(19) United States
(12) Patent Application Publication
(10) Pub. No.: US 2020/0051466 A1
(43) Pub. Date: Feb. 13, 2020

(54) COVER MEMBER AND DISPLAY DEVICE

(71) Applicant: AGC INC., Chiyoda-ku (JP)

(72) Inventors: Nobuhiro INOUE, Tokyo (JP); Koji KOGANEZAWA, Tokyo (JP); Mineo MORI, Tokyo (JP); Yuichi SUZUKI, Tokyo (JP); Eita NAGAMURA, Tokyo (JP); Ryota NAKAJIMA, Tokyo (JP)

(73) Assignee: AGC INC., Chiyoda-ku (JP)

(21) Appl. No.: 16/654,284

(22) Filed: Oct. 16, 2019

Related U.S. Application Data
(63) Continuation of application No. PCT/JP2018/016037, filed on Apr. 18, 2018.

(30) Foreign Application Priority Data
Apr. 19, 2017 (JP) 2017-082642

(51) Int. Cl. G09F 9/00; B32B 3/04; B32B 17/06; G06F 1/16

(52) U.S. Cl. CPC G09F 9/00; B32B 3/04; B32B 2457/20; G06F 1/1601; B32B 17/06

(57) ABSTRACT

The purpose of the present invention is to provide a cover member that excels in impact resistance. The present invention relates to a cover member disposed on the display panel of a display device, wherein the cover member is provided with a glass plate and a resin-molded article disposed at the periphery of the glass plate, the principal surface of the glass plate being smaller than the principal surface of the display panel.

### TECHNICAL FIELD

The present invention relates to a cover member and a display device.

### BACKGROUND ART

A cover member for protecting a display panel has been used hitherto in a display device (for example, see Patent Literature 1).

### CITATION LIST

### Patent Literature

Patent Literature 1: JP-A-2012-111688

### SUMMARY OF INVENTION

### Technical Problem

Display devices in the background art have been often used in a stationary state. However, in recent years, an increasing number of display devices have been used under a mobile environment.

For example, display devices such as smartphones or tablet terminals are fundamentally used under an environment where they are carried. Some display devices are attached to opening/closing doors of household electric appliances such as refrigerators. Such a display device moves in accordance with an opening/closing operation of an opening/closing door.

A glass sheet for use as a cover member of such a display device is more likely to collide with an object than a glass sheet in the background art. Therefore, the glass sheet is demanded to have excellent impact resistance against the collision.

Furthermore, in recent years, in-vehicle display devices such as car navigation devices or rear seat entertainment (RSE) devices on which passengers on rear seats watch video and the like have been popular.

Such an in-vehicle display device may be requested to have impact resistance high enough not to be cracked even if a head portion or the like of a passenger collides with the display device when a vehicle accident occurs.

Therefore, the present inventors examined impact resistance of a glass sheet (“cover glass 22” in Patent Literature 1) covering a display panel (“display module 21” in Patent Literature 1) in a display device (“display device” in Patent Literature 1) shown in FIG. 3 of Patent Literature 1. As a result, it was found that the impact resistance was insufficient in some cases (as will be described in detail later).

The present invention has been developed in consideration of the aforementioned point. An object of the present invention is to provide a cover member excellent in impact resistance, and a display device using the cover member.

### Solution to Problem

As a result of keen examinations, the present inventors found that the aforementioned object could be attained by employing the following configuration, and completed the present invention.

That is, a cover member according to a configuration of the present invention is a cover member to be disposed on a display panel of a display device, the cover member including a glass sheet, and a resin-formed article that is disposed around the glass sheet, in which the glass sheet has a main surface smaller than a main surface of the display panel.

Furthermore, a cover member according to a configuration of the present invention is a cover member including: a glass sheet, a resin-formed article that is disposed around the glass sheet, and a bonding layer that is disposed between the glass sheet and the resin-formed article so as to join a side surface of the glass sheet with the resin-formed article, in which the bonding layer includes 0.1 mass % or less of an acrylic resin.

In addition, a display device according to a configuration of the present invention is a display device including a display panel and a cover member, in which the cover member is disposed on the display panel, and includes a glass sheet and a resin-formed article disposed around the glass sheet, and the glass sheet has a main surface smaller than a main surface of the display panel.

### Advantageous Effects of Invention

According to the present invention, it is possible to provide a cover member excellent in impact resistance, and a display device using the cover member.

### BRIEF DESCRIPTION OF DRAWINGS

FIG. 1 is a sectional view illustrating a display device in the background art.

FIG. 2 is a perspective view illustrating a cover member.

FIG. 3 is a sectional view illustrating a display device with the cover member.

FIG. 4 is a sectional view illustrating Modification 1 of the cover member.

FIG. 5 is a sectional view illustrating Modification 2 of the cover member.

FIG. 6 is a sectional view illustrating Modification 1 of the display device.

FIG. 7 is a sectional view illustrating Modification 2 of the display device.

FIG. 8 is a sectional view illustrating Modification 3 of the display device.

FIG. 9 is a sectional view illustrating Modification 4 of the display device.

FIG. 10 is a sectional view illustrating Modification 5 of the display device.

FIG. 11 is a sectional view for explaining a position where cross-sectional secondary moment l₁ of the display device according to the present invention is calculated.

FIG. 12 is a sectional view for explaining a position where cross-sectional secondary moment l₁ of the display device in the background art is calculated.

FIG. 13 is a perspective view illustrating a specimen.

FIG. 14 is a sectional view taken on line C-C in FIG. 13.

FIG. 15 is a plan view illustrating the specimen.

### DESCRIPTION OF EMBODIMENTS

### [Conventional Display Device]

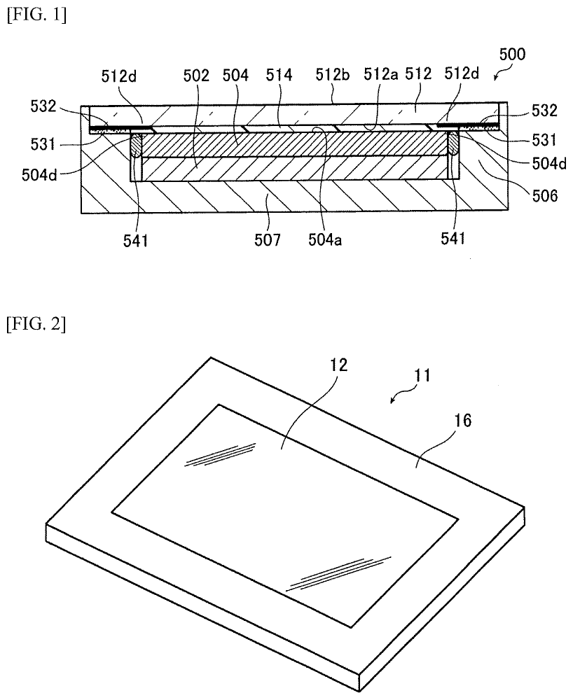

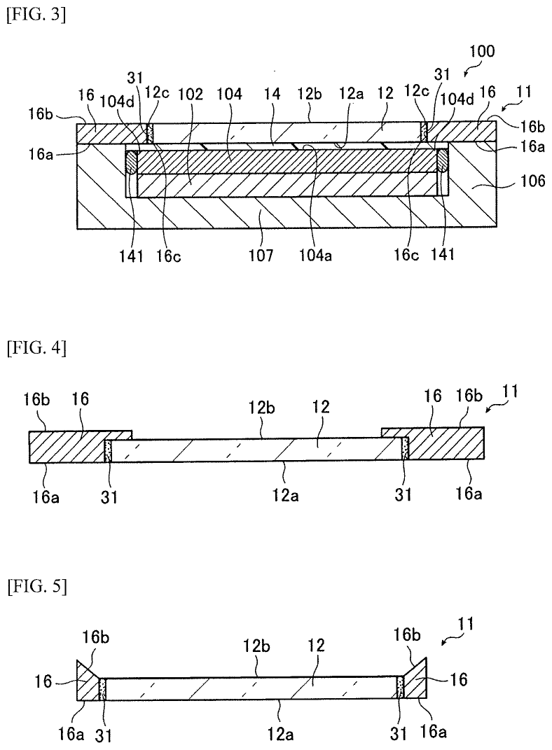

First, a conventional display device represented by a display device illustrated in FIG. 3 of Patent Literature 1 will be described with reference to FIG. 1.

FIG. 1 is a sectional view illustrating a conventional display device 500.

The display device 500 has a housing 506 storing various members. A backlight unit 502 and a display panel 504 are mounted on a housing bottom plate 507 in this order. The housing bottom plate 507 is a bottom plate of the housing 506. Here, the display panel 504 is a liquid crystal panel. A wiring 541 connected to the display panel 504 is disposed to a place inside the housing 506 and outside the display panel 504 which has a plate-like shape.

A glass sheet 512 as a cover glass is attached to the display panel 504 through a transparent pressure-sensitive adhesive layer 514. The glass sheet 512 has a first main surface 512a and a second main surface 512b. The first main surface 512a faces the display panel 504, and the second main surface 512b is located on the opposite side to the first main surface 512a so as not to face the display panel 504.

The first main surface 512a and the second main surface 512b have the same dimensions, and are larger than a main surface 504a which is a display surface of the display panel 504.

A black shielding portion 532 is formed like a frame at an edge of the first main surface 512a in the glass sheet 512. The black shielding portion 532 shields the wiring 541 so that the wiring 541 cannot be visually recognized from the second main surface 512b side.

An end portion (including the shielding portion 532) of the glass sheet 512 on the first main surface 512a side is bonded to the housing 506 through a bonding layer 531.

In the case where the display device 500 configured thus is an in-vehicle display device, when a traffic accident of a vehicle occurs, a head portion of a passenger may collide with the second main surface 512b of the glass sheet 512.

Thus, the glass sheet 512 is demanded to have impact resistance high enough not to be cracked even if the head portion collides therewith.

However, in the conventional display device 500, the size of the glass sheet 512 is larger than the size of the display panel 504.

Therefore, at the time of the collision, stress is applied to a position 512d in the glass sheet 512 facing a corner portion 504d of the display panel 504. Thus, in the glass sheet 512, cracking tends to occur in the position 512d, and the impact resistance is insufficient.

### [Preferred Embodiments of Cover Member and Display Device]

Next, preferred embodiments of a cover member and a display device according to the present invention will be described.

### <Configuration>

FIG. 2 is a perspective view illustrating a cover member 11. FIG. 3 is a sectional view illustrating a display device 100 including the cover member 11. The display device 100 is, for example, an in-vehicle display device such as a car navigation device. However, the display device 100 is not limited thereto.

The display device 100 has a housing 106 storing various members. An opening portion is formed in the housing 106. A backlight unit 102 and a display panel 104 are mounted in the housing 106. As shown in FIG. 3, the display panel 104 is mounted on the backlight unit 102. In this embodiment, the display panel 104 is a liquid crystal panel. A wiring 141 connected to the display panel 104 is disposed to a place inside the housing 106 and outside the display panel 104 which has a plate-like shape.

The configurations of the backlight unit 102 and the display panel 104 are not particularly limited, but known configurations may be used. In the same manner, the material and the like of the housing 106 (including a housing bottom plate 107) are not particularly limited, but acrylonitrile-butadiene-styrene resin (ABS resin) can be exemplified.

The display device 100 is not limited to a display device having a liquid crystal panel as the display panel 104. For example, the display device 100 may be a display device having an organic EL panel, a PDP (Plasma Display Panel), an electronic ink type panel, or the like. Depending on a kind of the display panel 104, the backlight unit 102 may not be included. In addition, a touch panel or the like may be included. As the touch panel, an electrostatic capacitance type touch panel, a resistive film system touch panel, or the like may be used.

The cover member 11 constitutes a part of the display device 100, and is disposed on the display panel 104. More in detail, the cover member 11 includes a glass sheet 12 disposed on a main surface 104a which is a display surface of the display panel 104, and a resin-formed article 16 disposed around the glass sheet 12.

The glass sheet 12 constituting the cover member 11 has main surfaces. That is, the glass sheet 12 has a first main surface 12a and a second main surface 12b. The first main surface 12a faces the display panel 104, and the second main surface 12b is located on the opposite side to the first main surface 12a so as not to face the display panel 104.

The main surfaces (the first main surface 12a and the second main surface 12b) of the glass sheet 12 are smaller than the main surface 104a of the display panel 104.

The glass sheet 12 further includes a side surface 12c which is connected to the first main surface 12a and the second main surface 12b. The side surface 12c of the glass sheet 12 may be a surface which is cut off and left as it is, a surface having a chamfered portion, a surface processed mechanically, or a surface processed chemically. The chamfered portion can be formed by conducting a polishing with grindstone or conducting a laser processing to a corner portion of the side surface 12c. As a method for mechanical processing, for example, a method for polishing the side surface 12c with a grindstone or a brush may be used. As a method for chemical processing, for example, a method for etching the side surface 12c with chemical may be used.

Arithmetic mean roughness Ra of the side surface 12c of the glass sheet 12 is preferably 0.1 nm or more. Consequently, when the resin-formed article 16 is disposed around the glass sheet 12, resin constituting the resin-formed article 16 and the bonding layer 31 enters minute irregularities on the side surface 12c of the glass sheet 12. Thus, the resin-formed article 16 and the glass sheet 12 can be connected firmly. The arithmetic mean roughness Ra of the side surface 12c of the glass sheet 12 is more preferably 1 nm or more, and further more preferably 5 nm or more.

The arithmetic mean roughness Ra of the side surface 12c of the glass sheet 12 is preferably 50,000 nm or less. In the case where the arithmetic mean roughness Ra of the side surface 12c of the glass sheet 12 is made not more than the upper limit value, when the resin-formed article 16 is disposed around the glass sheet 12, the resin constituting the resin-formed article 16 and the bonding layer 31 can perfectly enter the minute irregularities on the side surface 12c of the glass sheet 12. Thus, gaps are hardly generated. Consequently, excellent appearance can be formed in the boundary between the side surface 12c of the glass sheet 12 and the resin-formed article 16 when a user visually recognizes the display device 100 shown in FIG. 3 from the second main surface 12b side of the glass sheet 12. In addition, in the case where the arithmetic mean roughness Ra of the side surface 12c of the glass sheet 12 is made not more than the upper limit value, cracks affecting the strength of the glass sheet 12 can be reduced so that the cover member 11 excellent in strength can be obtained. The arithmetic mean roughness Ra of the side surface 12c of the glass sheet 12 is more preferably 10,000 nm or less, further more preferably 1,000 nm or less, and particularly preferably 50 nm or less.

Incidentally, the arithmetic mean roughness Ra can be obtained by a method in accordance with JIS B0601 (2013).

The resin-formed article 16 constituting the cover member 11 has main surfaces (a first resin main surface 16a and a second resin main surface 16b). The first resin main surface 16a is a surface adjacent to the first main surface 12a of the glass sheet 12. The second resin main surface 16b is a surface adjacent to the second main surface 12b of the glass sheet 12.

The resin-formed article 16 further includes a resin inside surface 16c. The resin inside surface 16c is a surface connected to the first resin main surface 16a and the second resin main surface 16b, and is also a surface facing the side surface 12c of the glass sheet 12.

The resin inside surface 16c of the resin-formed article 16 is joined to the side surface 12c of the glass sheet 12 so that the resin-formed article 16 is integrated with the glass sheet 12. The integration form is not particularly limited. For example, according to another form, the resin inside surface 16c and the side surface 12c may be joined through the bonding layer 31 (not shown in FIG. 2).

For the cover member 11, a form in which the main surfaces of the glass sheet 12 and the resin-formed article 16 are so-called “flush” with each other is preferred.

The main surfaces of the glass sheet 12 and the resin-formed article 16 are regarded as “flush” if the height of the main surface of the resin-formed article 16 (a main surface adjacent to the main surface of the glass sheet 12) based on the main surface of the glass sheet 12 is within a range of from −50 μm to 50 μm in a region of 2 mm or less from a joint portion between the glass sheet 12 and the resin-formed article 16. The height is more preferably −20 μm to 20 μm, and further more preferably −10 μm to 10 μm.

As long as the main surfaces of the glass sheet 12 and the resin-formed article 16 are “flush” in the region of 2 mm or less from the joint portion, the main surfaces of the glass sheet 12 and the resin-formed article 16 may be not “flush” in a region more than 2 mm away from the joint portion.

Here, the “region of 2 mm or less from the joint portion between the glass sheet 12 and the resin-formed article 16” means, on the glass sheet 12 side, a region 2 mm or less away along the main surface of the glass sheet 12 from the interface between the side surface 12c of the glass sheet 12 and the bonding layer 31; and on the resin-formed article 16 side, a region 2 mm or less away along the main surface of the resin-formed article 16 from the interface between the resin inside surface 16c and the bonding layer 31.

It is preferable that the first main surface 12a of the glass sheet 12 and the first resin main surface 16a of the resin-formed article 16 are “flush” so that bubbles can be prevented from being generated in the attached surface when the cover member 11 and the display panel 104 are attached to each other through the pressure-sensitive adhesive layer 14.

It is preferable that the second main surface 12b of the glass sheet 12 and the second resin main surface 16b of the resin-formed article 16 are “flush” so that the design of the cover member 11 can be enhanced.

The lower limit of a difference in height between the main surfaces of the glass sheet 12 and the resin-formed article 16 is not limited. It is more preferable as the difference is smaller. However, the difference may be 0.1 μm or more.

In addition, a difference in height between a higher one of the second main surface 12b and the second resin main surface 16b and a bottom portion (formed of the bonding layer 31 here) of a groove formed in the boundary portion between the glass sheet 12 and the resin-formed article 16 is preferably 50 μm or less, more preferably 15 μm or less, and further more preferably 10 μm or less.

In the same manner, a difference in height between a higher one of the first main surface 12a and the first resin main surface 16a and a bottom portion (formed of the bonding layer 31 here) of a groove formed in the boundary portion between the glass sheet 12 and the resin-formed article 16 is preferably 20 μm or less, and more preferably 10 μm or less.

The first main surface 12a of the glass sheet 12 in the cover member 11 configured thus is attached to the main surface 104a, which is a display surface of the display panel 104, through the pressure-sensitive adhesive layer 14. The glass sheet 12 functions as a cover member covering the display panel 104.

The form in which the main surface 104a of the display panel 104 is attached on the cover member 11 may be a form in which the main surface 104a is attached on only the region of the first main surface 12a of the glass sheet 12 or a form in which the main surface 104a is attached on the first main surface 12a of the glass sheet 12 and a part of the first resin main surface 16a of the resin-formed article 16.

It is preferable that the main surface 104a of the display panel 104 is attached on the first main surface 12a of the glass sheet 12 and a part of the first resin main surface 16a of the resin-formed article 16, so as to increase the area of the pressure-sensitive adhesive layer 14 and increase the adhesive force thereof. Furthermore, in the form in which the first main surface 12a of the glass sheet 12 and a part of the first resin main surface 16a of the resin-formed article 16 are attached on the display panel 104 by use of the pressure-sensitive adhesive layer 14, the side surface 12c of the glass sheet 12 can be protected from being broken by impact, and the edge of the pressure-sensitive adhesive layer 14 can be hidden by the resin-formed article 16.

It is preferable that the pressure-sensitive adhesive layer 14 is transparent in the same manner as the glass sheet 12, and a difference in refractive index between the glass sheet 12 and the pressure-sensitive adhesive layer 14 is small. For example, a layer including transparent resin obtained by curing a liquid curable resin composition may be used as the pressure-sensitive adhesive layer 14. Alternatively, the pressure-sensitive adhesive layer 14 may be an OCA (Optical Clear Adhesive) film or tape. The thickness of the pressure-sensitive adhesive layer 14 is, for example, 5 to 500 μm, and preferably 50 to 200 μm.

On this occasion, a part of the first resin main surface 16a of the resin-formed article 16 which is not bonded to the main surface 104a of the display panel 104 may be bonded to the housing 106 through a not-shown bonding layer or the like.

### <Function and Effect>

In the display device 100 thus configured, an object may collide with the second main surface 12b of the glass sheet 12.

Particularly when the display device 100 is an in-vehicle display device, a head portion of a passenger may collide with the second main surface 12b of the glass sheet 12 at the time of a vehicle accident. Therefore, the glass sheet 12 is demanded to have impact resistance high enough not to be cracked even if the head portion collides therewith.

As described above, the conventional display device 500 described with reference to FIG. 1 tends to be cracked at the position 512d on the first main surface 512a side of the glass sheet 512.

However, in the display device 100 having the cover member 11, which is different from the conventional display device 500, the size of each of the first main surface 12a and the second main surface 12b of the glass sheet 12 is smaller than the size of the main surface 104a of the display panel 104. Incidentally, the fact that each main surface of the glass sheet 12 is smaller than the main surface of the display panel 104 means that the periphery of the main surface of the glass sheet is entirely settled within the periphery of the main surface of the display panel in top view of the cover member. That is, it means that the main surface of the glass sheet is included within the main surface of the display panel in top view. For example, when the glass sheet 12 is rectangular, it means that the longitudinal and lateral lengths of the glass sheet 12 are shorter than the longitudinal and lateral lengths of the display panel 104 respectively, so that the periphery of the glass sheet 12 does not protrude from the periphery of the display panel 104. When the glass sheet 12 is elliptic, it means that the long and short diameters of the glass sheet 12 are shorter than the long and short diameters of the display panel 104 respectively, so that the periphery of the glass sheet 12 does not protrude from the periphery of the display panel 104.

Therefore, at the time of collision, a corner portion 104d of the display panel 104 does not press the first main surface 12a side of the glass sheet 12. Thus, stress concentration on the vicinity of the corner portion 104d of the display panel 104 is avoided in the glass sheet 12, so that cracking in the glass sheet 12 can be suppressed from occurring. That is, the glass sheet 12 is excellent in impact resistance.

Incidentally, when the first main surface 12a of the glass sheet 12 is, for example, supported by a protruding part of the housing 106, there is a concern that the protruding part may press the first main surface 12a side of the glass sheet 12 to generate cracking at the time of collision.

It is therefore preferable that the glass sheet 12 is supported by the resin-formed article 16 only through the joint between the side surfaces 12c of the glass sheet 12 and the resin-formed article 16. That is, it is preferable that the glass sheet 12 is not supported, for example, by the housing 106.

### <Other Effects>

For example, when the second resin main surface 16b of the resin-formed article 16 is higher than the second main surface 12b of the glass sheet 12, a depression is formed by the second main surface 12b of the glass sheet 12 and the resin inside surface 16c. Dust and dirt tend to be collected in the depression.

On the other hand, in the cover member 11, the second main surface 12b of the glass sheet 12 and the second resin main surface 16b of the rein-formed article 16 are “flush”. Therefore, the depression is not formed, and dust and dirt are hardly collected.

In the cover member 11, the first main surface 12a of the glass sheet 12 and the first resin main surface 16a of the rein-formed article 16 are “flush”. Therefore, for example, an effect that the cover member 11 is easily placed in the housing 106 can be also expected.

Incidentally, when the first main surface 12a and the first resin main surface 16a are not “flush” but a step is formed therebetween, the thickness of the pressure-sensitive adhesive layer 14 may be increased so that the step can be canceled.

In the conventional display device 500 described with reference to FIG. 1, the cover member is the glass sheet 512 itself.

On the other hand, the cover member 11 according to the embodiment includes the glass sheet 12 and the resin-formed article 16 provided in the periphery part thereof. Generally, resin can be processed more easily than glass. Therefore, higher dimensional accuracy tends to be obtained in the cover member 11 than in the conventional cover member (glass). In addition, there is another advantage that the degree of freedom for design is higher.

Further, resin is lighter in weight than glass. Therefore, in the case of forming the cover member 11 and the conventional cover member (glass) with the same area, the cover member 11 can be made lighter in weight than the conventional cover member (glass). In recent years, there is a tendency that the display device 100 increases in scale. In accordance therewith, each member is demanded to be lighter in weight. The cover member 11 can satisfy the demand.

In the conventional display device 500 described with reference to FIG. 1, the shielding portion 532 for shielding the wiring 541 is provided as described above.

On the other hand, in the display device 100 using the cover member 11 according to the embodiment, the size of the glass sheet 12 is smaller than the size of the display panel 104. Therefore, the resin-formed article 16 is also present on the main surface 104a side of the display panel 104, so that the wiring 141 beside the display panel 104 can be shielded. That is, in the display device 100, a shielding portion does not have to be provided in the cover member 11, so that the number of processes can be reduced.

In the cover member 11, the glass sheet 12 and the resin-formed article 16 are joined through the bonding layer 31. When a layer having a waterproof function is used as the bonding layer 31, a high waterproof function can be also attained.

### <Modifications>

The cover member 11 is not limited to the form described with reference to FIG. 2 and FIG. 3. For example, in the form of FIG. 3, the main surfaces of the glass sheet 12 and the resin-formed article 16 are “flush” with each other. The cover member 11 is not limited thereto, but various forms may be used.

FIG. 4 is a sectional view illustrating Modification 1 of the cover member 11. As shown in FIG. 4, a part of the resin-formed article 16 may cover the edge of the second main surface 12b by protruding on the second main surface 12b side of the glass sheet 12. In this form, it is preferable that the first main surface 12a of the glass sheet 12 and the first resin main surface 16a of the resin-formed article 16 are “flush”. Incidentally, according to another form, the first main surface 12a and the second main surface 12b of the glass sheet 12, and the first resin main surface 16a and the second resin main surface 16b of the resin-formed article 16 may be replaced by each other respectively.

FIG. 5 is a sectional view illustrating Modification 2 of the cover member 11. As shown in FIG. 5, according to another form, the height of the second resin main surface 16b of the resin-formed article 16 (the thickness of the resin-formed article 16) may increase gradually as goes away from the glass sheet 12. Incidentally, according to another form, the first main surface 12a and the second main surface 12b of the glass sheet 12, and the first resin main surface 16a and the second resin main surface 16b of the resin-formed article 16 may be replaced by each other respectively.

In addition, although not shown, a convex portion may be provided on the first resin main surface 16a of the resin-formed article 16 so that the convex portion can be used for positioning when the resin-formed article 16 is attached to the housing 106. In this case, for example, a concave portion which is shaped so that the convex portion of the resin-formed article 16 can be fitted thereto is provided in the housing 106.

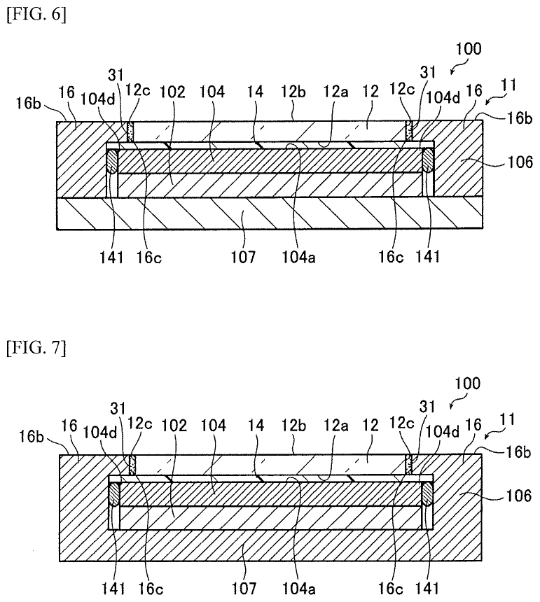

FIG. 6 is a sectional view illustrating Modification 1 of the display device 100. As shown in FIG. 6, a part of the resin-formed article 16 in the cover member 11 may form a part of the housing 106 in the display device 100 by protruding toward the housing bottom plate 107.

FIG. 7 is a sectional view illustrating Modification 2 of the display device 100. As shown in FIG. 7, the housing 106 (including the housing bottom plate 107) of the display device 100 may be entirely constituted by only the resin-formed article 16 of the cover member 11.

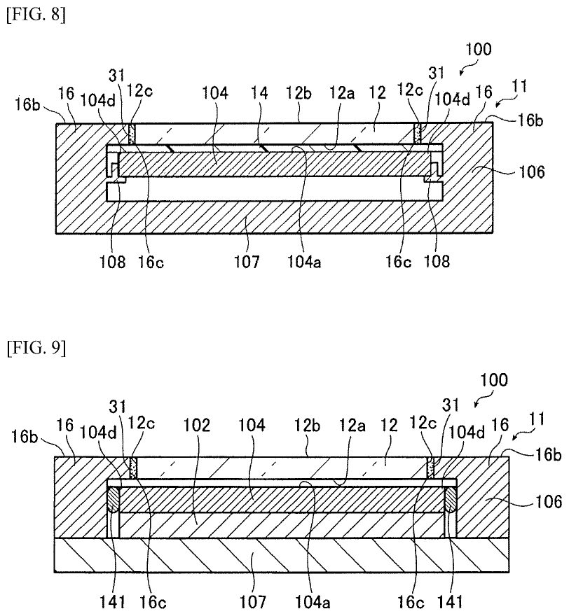

FIG. 8 is a sectional view illustrating Modification 3 of the display device 100. In FIG. 8, the backlight unit 102 and the wiring 141 are not illustrated. As shown in FIG. 8, the resin-formed article 16 constituting the housing 106 may form a support portion 108 for supporting the display panel 104.

FIG. 9 is a sectional view illustrating Modification 4 of the display device 100. In FIG. 9, the cover member 11 and the display panel 104 are not attached through the pressure-sensitive adhesive layer 14. As shown in FIG. 9, in the display device 100, the cover member 11 and the display panel 104 do not have to be always attached through the pressure-sensitive adhesive layer 14.

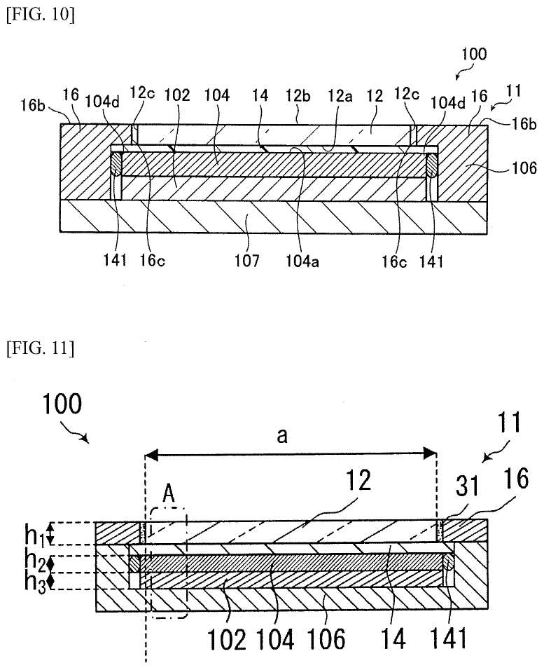

FIG. 10 is a sectional view illustrating Modification 5 of the display device 100. In FIG. 10, the glass sheet 12 of the cover member 11 is not joined to the resin-formed article 16 through the bonding layer 31, but the cover member 11 is supported only by the display panel 104 through the pressure-sensitive adhesive layer 14. As shown in FIG. 10, the glass sheet 12 of the cover member 11 does not have to be always joined to the resin-formed article 16.

In a display device including an in-vehicle display device, the cover member 11 is demanded to have impact resistance excellent enough not to be cracked even if a head portion or the like of a passenger collides with an end portion of the display device at the time of a collision accident of a vehicle.

The present inventors found that the impact resistance of the cover member 11 is excellent when the cover member 11 satisfies the following Expression (1).

l₁=a(t₁+t₂+t₃)³/12≥150 (mm⁴) (1)

In the Expression (1), respective items are designated as below.

l₁: cross-sectional secondary moment (unit: mm⁴) at an end portion of a glass sheet constituting a cover member (first layer)

a: width (also referred to as short side) (unit: mm) of the glass sheet constituting the cover member

tₙ: thickness [n is an integer of 1 to 3] (unit: mm) of a member of an n^{th} layer from the cover member side

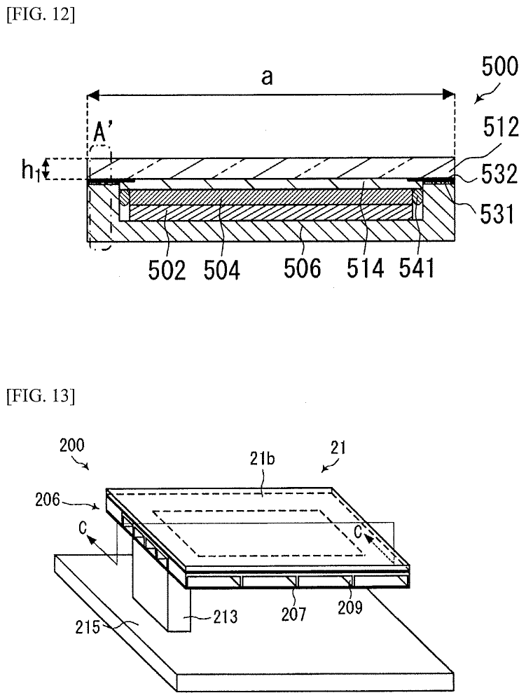

A position where the cross-sectional secondary moment l₁ at the end portion of the glass sheet constituting the cover member 11 is calculated will be described with reference to FIG. 11 and FIG. 12. FIG. 11 is a sectional view of the display device 100 according to the present invention, and FIG. 12 is a sectional view showing the conventional display device 500.

As shown in FIG. 11, in the display device 100 according to the present invention, the short side a is regarded as the width between the opposite end portions of the glass sheet 12 constituting the cover member 11. In an end portion of the glass sheet 12, the cross-sectional secondary moment l₁ at the end portion of the glass sheet constituting the cover member 11 is calculated. The display device shown in FIG. 11 has a lamination structure in which the cover member 11 (glass sheet 12) is the first layer, which is followed by the pressure-sensitive adhesive layer 14, the display panel 104, the backlight unit 102 and the housing 106 sequentially, as shown in the region A illustrated by the alternate long and short dash line.

The pressure-sensitive adhesive layer 14 has a sufficiently small thickness and has a Young's modulus much smaller than any other member. Accordingly, the pressure-sensitive adhesive layer 14 can be ignored when the cross-sectional secondary moment l₁ at the end portion of the glass constituting the cover member 11 is calculated. In addition, the housing 106 is often made of resin such as ABS resin, and has a Young's modulus smaller than any other member. In the present description, when the cross-sectional secondary moment l₁ at the end portion of the glass constituting the cover member 11 is calculated, the housing 106 is not taken into consideration for the calculation on the assumption that the housing 106 is made of resin.

However, when the housing 106 is made of not resin but a member with a large Young's modulus, the housing 106 may be taken into consideration when the cross-sectional secondary moment l₁ at the end portion of the glass constituting the cover member 11 is calculated.

Accordingly, in the display device 100 according to the present invention shown in FIG. 11, the cross-sectional secondary moment l₁ at the end portion of the glass sheet constituting the cover member 11 can be calculated using the thicknesses of the cover member 11 (glass sheet 12), the display panel 104 and the backlight unit 102, on the assumption that the cover member 11 (glass sheet 12), the display panel 104 and the backlight unit 102 are regarded as the first layer, the second layer and the third layer respectively.

Incidentally, when the display panel 104 is an organic EL panel, the backlight unit 102 may be absent. In addition, even in the configuration of the display device 100, there may be a gap between the display panel 104 and the backlight unit 102. In those cases, the cross-sectional secondary moment l₁ can be calculated without considering the backlight unit 102 but using the thicknesses of the cover member 11 (glass sheet 12) and the display panel 104, on the assumption that the display device 100 has a two-layer structure (t₃=0) in which the cover member 11 (glass sheet 12) and the display panel 104 are regarded as the first layer and the second layer respectively.

As shown in FIG. 12, in the conventional display device 500, assume that the short side a is the width between the opposite end portions of the glass sheet 512. In an end portion of the glass sheet 512, the cross-sectional secondary moment l₁ at the end portion of the glass sheet constituting the cover member is calculated. In the case of the display device shown in FIG. 12, the display device has a lamination structure in which the glass sheet 512 is the first layer, which is followed by the shielding portion 532, the bonding layer 531 and the housing 506 sequentially, as shown in a region A′ illustrated by the alternate long and short dash line.

The shielding portion 532 has a sufficiently small thickness. Accordingly, as well as the bonding layer 531 and the housing 506, the shielding portion 532 can be ignored when the cross-sectional secondary moment l₁ at the end portion of the glass sheet constituting the cover member 11 is calculated.

Accordingly, in the conventional display device 500 shown in FIG. 12, the cross-sectional secondary moment l₁ at the end portion of the glass sheet constituting the cover member can be calculated using the thickness of the glass sheet 512 on the assumption that the display device 500 has a one-layer structure (t₂=t₃=0) in which the glass sheet 512 is regarded as the first layer.

It will be described in the later section of Examples that when the cross-sectional secondary moment l₁ at the end portion of the glass sheet constituting the cover member 11 obtained in the aforementioned procedure satisfies Expression (1), the impact resistance of the cover member 11 is excellent. That is, the section of Examples shows that the cover member is cracked when Expression (1) is not satisfied (Comparative Examples), while the cover member is not cracked when Expression (1) is satisfied (Working Examples).

The cross-sectional secondary moment l₁ at the end portion of the glass constituting the cover member 11 is preferably 900 (mm⁴) or more, more preferably 2,000 (mm⁴) or more, and further more preferably 2,500 (mm⁴) or more.

The thickness of the display panel 104 is preferably 1 to 2 mm, more preferably 1 to 1.5 mm, and further more preferably 1 to 1.3 mm.

The thickness of the backlight unit (light-guiding plate) 102 is preferably 1 to 10 mm, more preferably 2 to 6 mm, and further more preferably 3 to 5 mm.

### (Details of Respective Portions Constituting Cover Member)

Next, the respective portions used in the cover member 11 will be described more in detail.

### <Glass Sheet>

The first main surface 12a and the second main surface 12b of the glass sheet 12 may be rectangular or square. However, it is preferable that the first main surface 12a and the second main surface 12b of the glass sheet 12 have the same size. In addition, the first main surface 12a and the second main surface 12b of the glass sheet 12 may be rectangular or square with a round corner portion. Alternatively the first main surface 12a and the second main surface 12b of the glass sheet 12 may be elliptic or circular.

The size of each of the main surfaces (the first main surface 12a and the second main surface 12b) of the glass sheet 12 has to be smaller than the size of the main surface of the display panel 104. However, it is preferable that the size of each of the main surfaces of the glass sheet 12 is equal to the size of a region (active area) in the panel size 104 where a display image is displayed or larger than the size of the active area.

The sheet thickness (length of the side surface 12c) of the glass sheet 12 is, for example, 0.5 to 2.5 mm, preferably 0.7 to 2.0 mm, and more preferably 1.1 to 2.0 mm.

The other shapes and sizes of the glass sheet 12 are determined suitably in accordance with the shape or the like of the display device 100. At least one main surface of the first main surface 12a and the second main surface 12b of the glass sheet 12 may have a bent portion partially.

A method for manufacturing the glass sheet 12 is not particularly limited, but the glass sheet 12 may be manufactured by a method known in the background art. For example, the glass sheet 12 can be manufactured in such a manner that a glass raw material known in the background art is melted into molten glass, and then formed into a sheet-like shape by a float process, a fusion process, a slot-down draw process, a redraw process, a pull-up process or the like.

A glass composition of the glass sheet 12 is not limited particularly.

The glass sheet 12 may be made of a plurality of glass sheets laminated by thermally welding or the like. In that case, glass compositions of the glass sheets may be the same as one another or different from one another.

The glass sheet 12 may be a strengthened glass subjected to physical strengthening treatment or chemical strengthening treatment. Methods known in the background art may be used as a method for the physical strengthening treatment and a method for the chemical strengthening treatment. In the case of the chemical strengthening treatment, it is necessary to select a glass containing an alkali component as the glass sheet 12. Preferred examples of such glasses include soda lime glass, alkali aluminosilicate glass, etc.

A not-shown functional layer may be formed on at least one main surface of the first main surface 12a and the second main surface 12b of the glass sheet 12. Examples of such functional layers include an antireflection layer, an antiglare layer (AG layer), an antifouling layer (such as an anti-fingerprint layer (AFP layer)), a light shielding layer, etc.

The functional layer may be formed by processing a surface layer of the glass sheet 12, or may be formed by disposing another layer on the surface of the glass sheet 12.

### <Bonding Layer>

The bonding layer 31 exerts bonding force to contribute to joint between the side surfaces 12c of the glass sheet 12 and the resin-formed article 16.

It is preferable that a layer which does not have electric conductivity but has as excellent insulation as possible is used as the bonding layer 31. As such a kind of bonding layer 31, for example, a use of a layer including a bonding agent containing silicone-based, urethane-based or epoxy-based resin component monomer can be exemplified. Among them, it is preferable to use the bonding layer containing the urethane-based resin component monomer. Further, it is also preferable to use a bonding layer containing a silane coupling agent.

When the bonding layer 31 contains acrylic resin as a compound excluding the resin component monomer and the silane coupling agent, it is preferable that the content of acrylic resin is 0.1 mass % or less based on dry weight excluding volatile components such as a solvent contained in the boding layer. This is because acrylic resin such as polymethacrylate (PMMA) which is comparatively low in impact resistance is reduced to prevent the bonding layer 31 from being easily cracked by external impact, so that the cover member 11 high in impact resistance can be obtained. The content of acrylic resin is more preferably 0.08 mass % or less, and further more preferably 0.05 mass % or less.

The lower limit value of the content of acrylic resin is not particularly limited, but it is preferable that acrylic resin is not contained.

Incidentally, although not limited, the acrylic resin contained in the bonding layer 31 can be detected by infrared microspectroscopic analysis (IR microspectroscopic analysis) or pyrolysis gas chromatograph mass scpectroscopy (pyrolysis GC/MS). When the amount of the bonding layer 31 is small, the bonding layer 31 is dispersed and dissolved in tetramethyl ammonium hydroxide (TMAH) and analyzed by pyrolysis GC/MS so that the structure of the bonding layer 31 can be grasped in detail.

### <Resin-Formed Article (Resin)>

The resin-formed article 16 is not particularly limited as long as it is disposed around the glass sheet 12. In top view of the cover member 11, the resin-formed article 16 may have a frame-like shape so that the resin-formed article 16 is disposed to enclose all the circumference of the glass sheet 12, or may have a form in which the resin-formed article 16 is not disposed in a part of the circumference of the glass sheet 12. In addition, at least one main surface of the first resin main surface 16a and the second resin main surface 16b of the resin-formed article 16 may have a bent portion partially.

Since the cover member 11 is used in the display device 100, it is preferable that a material which does not have electric conductivity but has as excellent insulation as possible is used as the material of the resin forming the resin-formed article 16. Thermoplastic resin can be used preferably.

### <<Thermoplastic Resin>>

The thermoplastic resin is not particularly limited as long as it can be formed integrally with the glass sheet 12 by melt-forming. Examples of the thermoplastic resin include thermoplastic polyester resin (such as polyethylene terephthalate resin, polybutylene terephthalate resin, etc.), a mixture of thermoplastic polyester resin and another resin, a polymer alloy, modified polyester resin, aromatic polyester resin, liquid crystal polymer, polyphenylene sulfide resin, polyamide resin, polyimide resin, polyamide imide resin, polyether imide resin, polyolefin resin (such as polyethylene resin, polypropylene resin, polybutene resin, etc.), modified resins of those resins, polymethylpentene resin, polystyrene resin, poly(α-methylstyrene) resin, AS resin (acrylonitrile-styrene resin), ABS resin, petroleum resin, polycarbonate resin, polysulfone resin, polyether sulfone resin, polyaryl sulfone resin, polyarylate resin, polyoxymethylene resin, polyether ether ketone resin, polyaryl ether nitrile resin, polybenzimidazole resin, polyvinyl chloride resin, fluororesin, polyphenylene oxide resin, modified polyphenylene oxide resin, (meth)acrylic resin, norbornene resin, thermoplastic polyurethane resin, etc.

### (Liquid Crystal Polymer and Crystalline Resin)

Among those thermoplastic resins, the liquid crystal polymer and the crystalline resins (excluding the liquid crystal polymer) are preferred since they are excellent in melt-fluidity due to low shearing stress so that they can be injected into a mold under a low pressure and they hardly generate burrs.

The liquid crystal polymer (LCP) may be a liquid crystal polymer whose liquid crystal layer structure is nematic, smectic, or discotic. The liquid crystal polymer (LCP) may chiefly have a recurring unit derived from an aromatic hydroxycarboxylic acid, a recurring unit derived from an aromatic dicarboxylic acid, or a recurring unit derived from an aromatic diol. Particularly, melt-moldable thermotropic liquid crystal polymer is preferred.

Such polymers with various physical properties are commercially available, and any of them can be used preferably. For example, Rodrun LC-5000, LC-5000F and LC-5000H (tradenames, all made by Unitika Ltd.), Xydar SRT-300, SRT-500, FSR-315, RC-210, FC-110, FC-120 and FC-130 (tradenames, all made by Nippon Petrochemicals Co., Ltd.), Ekonol E2000 and Ekonol E6000 (tradenames, all made by Sumitomo Chemical Industry Company Limited), EPE-240G30, Novaccurate E322G30 and E335G30 (tradenames, all made by Mitsubishi Chemical Corporation), Vectra A950, Vectra A130, Vectra C130, Vectra A230 and Vectra A410 (tradenames, all made by Polyplastics Co., Ltd.), BIAC (tradename, made by Japan Gore-Tex Inc.), OCTA (tradename, made by Dainippon Ink and Chemicals, Incorporated), Zenite (tradename, made by DuPont de Nemours, Inc.), Novaccurate (tradename, made by Mitsubishi Electric Engineering Co., Ltd.), SIVERAS (tradename, made by Toray Industries, Inc.), etc. can be used.

Examples of the crystalline resins (excluding the liquid crystal polymers) include polyphenylene sulfide resin (PPS), polyethylene terephthalate resin (PET), polybutylene terephthalate resin (PBT), aromatic polyester resin, polyether ether ketone resin (PEEK), polyether nitrile resin (PEN), polyamide resin (nylon resin) (such as polyamide 6, polyamide 66, polyamide 11, polyamide 12, polyamide 46, polyamide 620, polyamide 612, polyamide MDX 6, etc.), polyoxymethylene resin (POM), polyethylene resin (such as low density polyethylene, medium density polyethylene, high density polyethylene, etc.), polypropylene resin, polystyrene resin (such as syndiotactic polystyrene), polybutene resin, polymethylpentene resin, fluororesin, polyimide resin, etc.

As the crystalline resins (excluding the liquid crystal polymers), polyphenylene sulfide resin, polyethylene terephthalate resin, polybutylene terephthalate resin, aromatic polyester resin, polyamide resin, polyoxymethylene resin, and polyimide resin are preferred, and polyphenylene sulfide resin is more preferred.

<<Compound Containing Hydroxy Group and/or Epoxy Group>>

A compound which does not foam or is not decomposed when it is heated and melted with thermoplastic resin is preferred as the compound containing a hydroxy group and/or an epoxy group.

Examples of compounds containing hydroxy groups in their molecules include various alcohols, polyvinyl alcohol, modified polyvinyl alcohol, polyvinyl alcohol copolymer, polyvinyl butyral, ethylene glycol, glycerin, phenol, phenolic resin, those compounds modified with epichlorohydrin or the like, phenoxy resin, hydroxyethyl(meth)acrylate (HEMA), natural polymer (such as cellulose, cellulose derivative, starch, chitin, chitosan, cyclodextrin, trehalose, palatinose, maltose, etc.), etc.

Examples of compounds containing epoxy groups in their molecules include glycidyl alcohol, glycidyl (meth)acrylate, epoxy resin, etc.

The compound containing a hydroxy group and/or an epoxy group is preferably a polymeric compound containing a hydroxy group or an epoxy group, and more preferably a resin containing a hydroxy group or an epoxy group.

Phenoxy resin is preferred as the resin containing a hydroxy group, and epoxy resin is preferred as the resin containing an epoxy group.

Examples of the phenoxy resin include bisphenol A type phenoxy resin, bisphenol F type phenoxy resin, and copolymer type phenoxy resin of bisphenol A type and bisphenol F type. The mass-average molecular weight (equivalent value of polystyrene according to GPC measurement) of the phenoxy resin is preferably 10,000 to 200,000, and more preferably 20,000 to 100,000.

Commercially available ones may be selected as the phenoxy resin. Examples of the commercially available phenoxy resins include PKHC, PKHH, PKHJ, PKHB, PKFE and PKHP (tradenames, all made by InChem Corp.), YP-50, YP-50S, YP-55, YP-70 and FX239 (tradenames, all made by Tohto Kasei Co., Ltd.), Epikote E1256, Epikote E4250 and Epikote E4275 (tradenames, all made by Union Carbide Corporation), UCAR, PKHC and PKHH (tradenames, all made by Tohto Kasei Co., Ltd.), etc. Each of them may be used alone, or two or more kinds of them may be used together.

The hydroxy group content in the polymeric compound containing a hydroxy group is preferably 0.01 to 23 mol/kg-polymer, more preferably 0.1 to 15 mol/kg-polymer, and further more preferably 1 to 10 mol/kg-polymer. Particularly in the phenoxy resin, an especially preferable range of the hydroxy group content is 3 to 7 mol/kg-polymer (resin), and the most preferable range is 3 to 5 mol/kg-polymer (resin).

Examples of the epoxy resin include bisphenol type epoxy resin such as bisphenol A type epoxy resin, bisphenol F type epoxy resin, or bisphenol S type epoxy resin; novolac type epoxy resin such as phenol novolac type epoxy resin, o-cresol novolac type epoxy resin, or biphenyl novolac type epoxy resin; biphenyl type epoxy resin, naphthalene type epoxy resin, triphenylmethane type epoxy resin, dicyclopentadiene type epoxy resin, alicyclic epoxy resin, and glycidyl type epoxy resin such as glycidyl ether type epoxy resin or glycidyl ester type epoxy resin; etc. Each of them may be used alone, or two or more kinds of them may be used together.

In the same manner as the phenoxy resin, such epoxy resins with various physical properties are commercially available, and any of them can be used preferably in accordance with an object thereof.

The mass-average molecular weight (equivalent value of polystyrene according to GPC measurement) of the epoxy resin is preferably 700 to 200,000, and more preferably 900 to 100,000.

The epoxy group content in the polymeric compound containing an epoxy group is preferably 0.01 to 10 mol/kg-polymer, and more preferably 0.1 to 8 mol/kg-polymer.

Each of the phenoxy resin and the epoxy resin may be used alone, or the both may be used together.

Instead of blending the thermoplastic resin with the compound containing a hydroxy group and/or an epoxy group to make the resin composition, grafting the compound on the thermoplastic resin in advance or modifying the thermoplastic resin by the compound to introduce the hydroxy group and/or the epoxy group into the thermoplastic resin may be conducted.

### <<B Lending Ratio>>

The blending quantity of the compound containing a hydroxy group in its molecule and/or the compound containing an epoxy group in its molecule is preferably 1 to 90 parts by mass and more preferably 3 to 80 parts by mass, relative to 100 parts by mass of the thermoplastic resin.

When the blending quantity of the compound is too small, there is a case where sufficient adhesiveness between the resin composition and the glass sheet 12 cannot be obtained. When the blending quantity is too large, the fundamental characteristic of the thermoplastic resin as a base resin is impeded so that it may be difficult to obtain the resin-formed article 16 with high strength, or the adhesiveness may rather deteriorate.

On the other hand, when the blending quantity is within the aforementioned range, the adhesiveness between the resin composition and the glass sheet 12 is excellent, and the strength of the resin-formed article 16 is excellent.

### <<Filler Etc.>>

Further, filler may be blended in the resin composition. Examples of fibrous filler include inorganic fiber such as glass fiber, carbon fiber, potassium titanate fiber, aluminum borate fiber or metal fiber; organic fiber such as aramid fiber, vinylon fiber or hemp fiber; etc. Examples of filler with various shapes such as a granular shape, a spherical shape, a flaky shape, a needle-like shape, a sheet-like shape, etc. include silica, alumina, talc, clay, kaoline, aluminum hydroxide, magnesium hydroxide, calcium carbonate, etc. Examples of sheet-like filler include mica, glass flake, etc. Examples of hollow filler include shirasu balloon, glass balloon, various resin balloons, etc. Each of those fillers may be used alone, or two or more kinds of the fillers may be used together.

Further, a colorant, a pigment, a thermal stabilizer, an oxidation inhibitor, a stabilizer, an ultraviolet absorber, a compatibilizer, a dispersant, a lubricant, a mold releasing agent, and other additives may be blended in the resin composition. A small amount of another thermoplastic resin may be blended supplementarily.

### <<Preparation of Resin Composition>>

The resin composition can be prepared by various known methods. For example, the following method can be used. That is, the thermoplastic resin, the compound containing a hydroxy group and/or an epoxy group in its molecule, and further, if necessary, components of filler, etc. are premixed at a predetermined ratio by a V-type blender, a Henschel mixer or the like. After that, the premixed components are melted and kneaded by an extruder. The respective components may be supplied to an extruder individually so as to be melted and kneaded.

### (Method for Manufacturing Cover Member)

Next, description will be made about a method for manufacturing the cover member 11. However, the present invention is not limited to the method.

To manufacture the cover member 11, integral resin molding is, for example, used. Specifically, for example, a bonding agent which will serve as the bonding layer 31 is first applied to the side surface 12c of the glass sheet 12. Next, the glass sheet 12 applied with the bonding agent is mounted in a mold. After that, the aforementioned resin is injected into the mold to form the resin-formed article 16 so that the resin-formed article 16 is disposed around the glass sheet 12. Thus, the glass sheet 12 and the resin-formed article 16 are integrated.

The integral resin molding is, for example, performed by a molding method such as injection molding, transfer molding or insert molding.

Specifically, the glass sheet 12 is mounted in the mold in advance, and the mold is closed. Next, a resin composition in a melted state is injected into the mold. After the resin composition is solidified, the mold is opened and the molded article is taken out.

Normally in this case, a mold constituted by at least a movable mold and a fixed mold is used. First, the glass sheet 12 is mounted in the fixed mold, and the movable mold is closed, so that a molding cavity (air gap portion for molding) is defined around the glass sheet 12. Molten resin is injected into the molding cavity through a flow path provided in the mold in advance. Thus, the resin-formed article 16 is molded. After cooling, the mold is opened to obtain the cover member 11 in which the resin-formed article 16 is joined with the glass sheet 12.

Post-processing may be performed on the obtained cover member 11.

For example, in the resin-formed article 16 of the cover member 11, a not-shown functional layer may be formed on the first resin main surface 16a or the second resin main surface 16b. Examples of such functional layers include an antireflection layer, an antiglare layer (AG layer), an antifouling layer (such as an anti-fingerprint layer (AFP layer)), a light shielding layer, etc.

The functional layer may be formed by processing a surface layer of the resin-formed article 16, or may be formed by disposing another layer on the surface of the resin-formed article 16.

In addition, in the resin-formed article 16 of the cover member 11, a printing layer may be formed on the first resin main surface 16a or the second resin main surface 16b. In the case where a printing layer is provided as a logo, a design or the like on the second resin main surface 16b which can be visually recognized by a user when the cover member 11 is disposed on the display device 100 shown in FIG. 3, the cover member 11 can have excellent appearance. In the case where a printing layer is provided as a lot number or the like on the first resin main surface 16a which cannot be visually recognized by a user when the cover member 11 is disposed on the display device 100 shown in FIG. 3, the cover member 11 can be used easily in a manufacturing process.

In the resin-formed article 16 of the cover member 11, a concave portion may be formed on the first resin main surface 16a or the second resin main surface 16b, or a through hole may be formed to penetrate from the first resin main surface 16a to the second resin main surface 16b.

When the concave portion or the through hole is formed in the resin-formed article 16, another member may be fitted into the concave portion or the through hole. For example, when an electronic device such as an infrared sensor or a camera is disposed on the first main surface (12a, 16a) side of the cover member 11, a through hole may be formed in the resin-formed article 16. On this occasion, a member of glass, sapphire or the like may be fitted into the through hole in the resin-formed article 16 in order to protect the disposed electronic device. Thus, the electronic device can be protected suitably. Incidentally, a printing layer such as an infrared transmitting printing layer or a semitransparent printing layer may be provided in the other member of glass, sapphire or the like in order to match colors between the member and the resin-formed article 16.

### (Applications)

The display device 100 is used preferably as an in-vehicle display device such as a car navigation device or an RSE device on which passengers on rear seats can watch video and the like. However, the display device 100 is not limited thereto, but can be also used preferably as a display device of a mobile body which is used under a mobile environment. Examples of such mobile bodies include a car, a bike, a railway, an airplane, etc.

For example, since the glass sheet 12 has excellent impact resistance against collision, the display device 100 is also preferred as a display device such as a smartphone or a tablet terminal which is carried. In addition, for the same reason, the display device 100 is also preferred as a display device which is attached to an opening/closing door of a household electric appliance such as a refrigerator, a washing machine or a microwave oven.

### EXAMPLES

The embodiments of the present invention will be specifically described below along Examples and the like. However, the present invention is not limited by these Examples.

Incidentally, I-2/3/5/6/8/9/11/12 and II-2/3/5/6/8/9/11/12 are Working Examples, and I-1/4/7/10 and II-1/4/7/10 are Comparative Examples.

### <Preparation of Glass Sheet>

Aluminosilicate glass to be chemically strengthened (Dragontrail®, made by Asahi Glass Co., Ltd.) was used as the glass sheet. The glass sheet was processed as a member having thickness t₁ and dimensions (short side a and long side b) shown in Tables 1 and 2, and subjected to chemical strengthening so that thickness of a compressive stress layer reached 38 μm and surface compressive stress in the compressive stress layer reached 774 MPa.

<Preparation of Cover Member without Resin-Formed Article>

In I-1/4/7/10 and II-1/4/7/10, a light shielding portion was formed in a peripheral edge portion in a first main surface of each chemically strengthened glass sheet obtained thus, to prepare a cover member. Incidentally, an OCA film (“MHM-FWD” made by Nichiei Kakoh Co., Ltd.) was attached as a pressure-sensitive adhesive layer on each cover member, so as to prepare a laminate.

TABLE 1

| | | | | | cover member | |
|---|---|---|---|---|---|---|
| | | | | | (resin-formed | |
| | cover | resin- | | | article + | |
| | member | formed | glass sheet | | glass sheet) | |
| | (first layer) | article | short | long | short | long |
| | thickness t₁ | r | side a | side b | side H₂ | side W₂ |
| | mm | mm | mm | mm | mm | mm |
| I-1 | 2.0 | 0 | 80.0 | 150.0 | 80.0 | 150.0 |
| I-4 | 1.3 | 0 | 80.0 | 150.0 | 80.0 | 150.0 |
| I-7 | 1.1 | 0 | 80.0 | 150.0 | 80.0 | 150.0 |
| I-10 | 0.56 | 0 | 80.0 | 150.0 | 80.0 | 150.0 |
| II-1 | 2.0 | 0 | 200.0 | 300.0 | 200.0 | 300.0 |
| II-4 | 1.3 | 0 | 200.0 | 300.0 | 200.0 | 300.0 |
| II-7 | 1.1 | 0 | 200.0 | 300.0 | 200.0 | 300.0 |
| II-10 | 0.56 | 0 | 200.0 | 300.0 | 200.0 | 300.0 |

### <Preparation of Cover Member Using Glass-Resin Integrally Formed Article>

Each cover member in I-2/3/5/6/8/9/11/12 and II-2/3/5/6/8/9/11/12 had a configuration in which the aforementioned glass sheet and a frame-like resin-formed article provided in the periphery thereof were connected through a bonding layer.

Resin of PC/ASA (Poly-Carbonate/Acrylonitrile-Styrene-Acrylate-terpolymaer) [tradename: GS809HA, made by Techno-UMG Co., Ltd.) was used for the resin-formed article. The used PC/ASA resin had a glass transition point Tg at 100° C.

The bonding layer was formed using a bonding agent containing an urethane-based compound (2,4-tolylene diisocyanate) as resin component monomer, and a silane coupling agent (trimethoxysilylpropyl glycidyl ether).

Incidentally, influence of the compound contained in the bonding agent excluding the resin component monomer and the silane coupling agent was confirmed in advance. Generally, a bonding agent further added with acrylic resin has been used for improving handling. In this examination, polymethacrylate (PMMA) such as methyl methacrylate or dimethylaminoethyl methacrylate was used as the acrylic resin to examine the influence of the content thereof in the bonding agent.

Four kinds of bonding agents, that is, a bonding agent added with 10 mass % of PMMA based on dry weight excluding volatile components such as a solvent contained in the boding agent, a bonding agent added with 1 mass % of PMMA likewise, a bonding agent added with 0.1 mass % of PMMA likewise, and a bonding agent added with 0 mass % of PMMA (PMMA free), were prepared. Cover members were manufactured using those bonding agents by a manufacturing method which will be described later.

Each cover member constituted by a glass-resin integrally formed article having a configuration in which a glass sheet and a resin-formed article provided in a peripheral edge portion thereof were joined through a bonding layer was manufactured by a method disclosed in a third embodiment of WO2015/098300. First, glass sheets each having a short side a of 92 mm, a long side b of 153 mm and a thickness t of 1.8 mm were prepared, and the four kinds of bonding agents were applied to end surfaces of the glass sheets respectively. Successively, an apparatus of FIG. 8 described in WO2015/098300 was used to mold a resin-formed article on each of the glass sheets applied with the bonding agents. Resin to be used for the resin-formed article was heated to 290° C. in advance, and the temperature of a mold included in the used apparatus was set at 95° C. Thus, a resin-formed article having a width of 20 mm in planar view was molded in the periphery portion of the glass sheet.

On each cover member obtained thus, a bonding strength test between the glass sheet and the resin-formed article was performed. Specifically, the part of the resin-formed article in the obtained glass-resin integrally formed article was fixed, and a load applied within a main surface of the glass sheet was increased to confirm whether peeling occurred or not in the interface between the glass sheet and the resin-formed article. As a result, it was proved that in the cover member using the bonding agent added with 1 mass % of PMMA and the cover member using the bonding agent added with 10 mass % of PMMA, peeling tended to occur at the bonding layer in the bonding strength test, and peeling occurred more easily as the content of PMMA increased. It can be considered that this was because acrylic resin such as PMMA could not bear the load in the bonding strength test but triggered peeling in the interface.

Therefore, in the following examination, a cover member constituted by a glass-resin integrally formed article was obtained using a bonding agent having a PMMA content of 0 mass % (PMMA free). Incidentally, an OCA film (“MHM-FWD” made by Nichiei Kakoh Co., Ltd.) was attached as a pressure-sensitive adhesive layer on each cover member, so as to prepare a laminate.

TABLE 2

| | cover | resin-formed | | | cover member | |
|---|---|---|---|---|---|---|
| | member | article | | | (resin-formed | |
| | (first layer) | top view | glass sheet | | article + glass sheet) | |
| | thickness t₁ | width r | short side a | long side b | short side H₂ | long side W₂ |
| | mm | mm | mm | mm | mm | mm |
| I-2 | 2.0 | 12.5 | 55.0 | 125.0 | 80.0 | 150.0 |
| I-3 | 2.0 | 15 | 50.0 | 120.0 | 80.0 | 150.0 |
| I-5 | 1.3 | 12.5 | 55.0 | 125.0 | 80.0 | 150.0 |
| I-6 | 1.3 | 15 | 50.0 | 120.0 | 80.0 | 150.0 |
| I-8 | 1.1 | 12.5 | 55.0 | 125.0 | 80.0 | 150.0 |
| I-9 | 1.1 | 15 | 50.0 | 120.0 | 80.0 | 150.0 |
| I-11 | 0.56 | 12.5 | 55.0 | 125.0 | 80.0 | 150.0 |
| I-12 | 0.56 | 15 | 50.0 | 120.0 | 80.0 | 150.0 |
| II-2 | 2.0 | 25 | 150.0 | 250.0 | 200.0 | 300.0 |
| II-3 | 2.0 | 30 | 140.0 | 240.0 | 200.0 | 300.0 |
| II-5 | 1.3 | 25 | 150.0 | 250.0 | 200.0 | 300.0 |
| II-6 | 1.3 | 30 | 140.0 | 240.0 | 200.0 | 300.0 |
| II-8 | 1.1 | 25 | 150.0 | 250.0 | 200.0 | 300.0 |
| II-9 | 1.1 | 30 | 140.0 | 240.0 | 200.0 | 300.0 |
| II-11 | 0.56 | 25 | 150.0 | 250.0 | 200.0 | 300.0 |
| II-12 | 0.56 | 30 | 140.0 | 240.0 | 200.0 | 300.0 |

### <Preparation of Specimen>

First, a specimen 200 was prepared for performing a test in which a rigid body model would collide therewith (referred to as “head impact test”). The specimen 200 will be described with reference to FIG. 13 to FIG. 15.

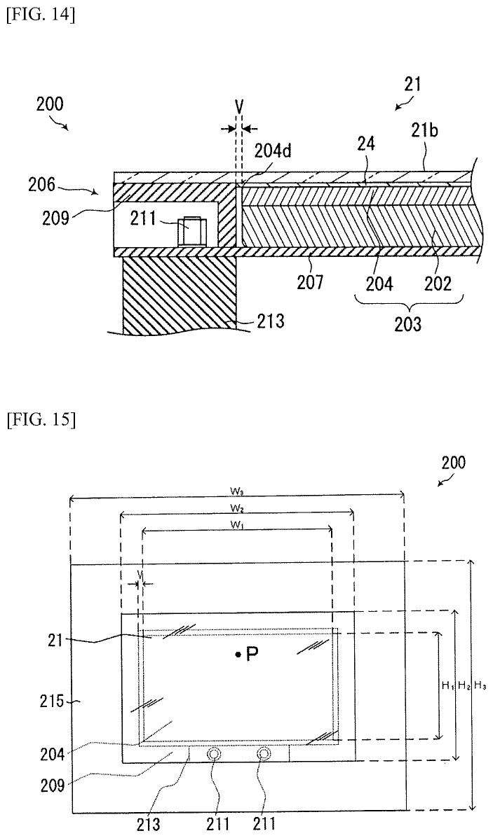

FIG. 13 is a perspective view illustrating the specimen. FIG. 14 is a sectional view taken on line C-C in FIG. 13. FIG. 15 is a plan view illustrating the specimen.

The specimen 200 is assumed to be an on-dash type in-vehicle display device.

The specimen 200 has a housing 206 constituted by a housing bottom plate 207 which is a thin plate, and four housing frames 209 which are disposed on a peripheral edge portions of the housing bottom plate 207. In a central region of the housing 206, a concave portion which is rectangular in top view is formed by the housing bottom plate 207 and the four housing frames 209.

In the concave portion, a display panel module 203 is disposed. The display panel module 203 has a backlight unit 202 and a display panel 204 as its main constituent members. A gap V between the display panel module 203 and each housing frame 209 is adjusted to be 3 mm. In addition, in the specimen 200, the backlight unit 202 and the display panel 204 are brought into contact with each other to eliminate an air gap therebetween.

An upper surface of the display panel 204 is in a lower position than an upper surface of each housing frame 209 disposed around the display panel 204, so as to form a concave portion. A pressure-sensitive adhesive layer 24 attached on a cover member 21 prepared as described above is attached to the upper surface of the display panel 204 such that the concave portion is filled. A boundary portion between the cover member 21 and the display panel 204 is a corner portion 204d.

The specimen formed thus is fixed to a solid fixing rib 213 integrated with a support plate 215 which is a flat plate, by a bolt 211 disposed in a gap inside the housing frame 209.

The specimen 200 was prepared using each cover member shown in Table 1 and Table 2. Incidentally, in the specimen 200, soda lime glass was used in place of the display panel 204, and a polycarbonate plate was used in place of the backlight unit 202. ABS resin was used for the housing 206. Incidentally, in the case of a display panel constituted by a typical TFT liquid crystal panel, the configuration thereof is fundamentally a laminated configuration in which a polarizing plate, a glass substrate (for example, 0.55 mm of sheet thickness), a liquid crystal layer, a glass substrate (for example, 0.55 mm of sheet thickness) and a polarizing plate are laminated. Since the polarizing plates and the liquid crystal layer are low in rigidity, the glass sheets dominate the rigidity. Accordingly, cross-sectional secondary moment at an end portion of the glass sheet was calculated using Young's moduli of the glass substrates constituting the display panel.

Incidentally, a pattern I and a pattern II shown in Table 3 were used as dimensions of each specimen designated as H₁ to H₃ and W₁ to W₃ shown in FIG. 15.

TABLE 3

| | H₁ | H₂ | H₃ | W₁ | W₂ | W₃ |
|---|---|---|---|---|---|---|
| pattern | (mm) | (mm) | (mm) | (mm) | (mm) | (mm) |
| I | 60 | 80 | 400 | 130 | 150 | 750 |
| II | 160 | 200 | 400 | 260 | 300 | 750 |

### <Evaluation of Impact Resistance (Head Impact Test)>

Next, the support plate 215 of the specimen 200 was placed on a horizontal surface, and a not-shown spherical rigid model (material: iron, diameter: 165 mm, mass: 19.6 kg) was made to fall down from a height of 794 mm and collide with a collision position P (see FIG. 15) of a second main surface 21b of the cover member 21 at a collision speed of 3.9 m/s so that energy at the time of collision reached 152.5 J.

A method of the test was referred to “Attachment 28 Technical Standards of Impact Absorption of Instrument Panel (announced on Sep. 26, 2003)” (hereinafter referred to as “Standards” simply) of “Article 20 Riding Device” of “Safety Standards of Road Transportation Vehicles” indicated by the Ministry of Land, Infrastructure, Transport and Tourism of Japan. According to the “Standards”, a spherical rigidity body model (material: iron, diameter: 165 mm, mass: 6.8 kg) is shot to collide at a collision speed of 6.7 m/s so that energy at the time of collision reaches 152.4 J. That is, in the head impact test using the specimen 200, the energy at the time of collision was set to be equivalent to that in “Standards”.

The collision position P (see FIG. 15) of the cover member 21 where the rigidity body model collided was set at a position closer to the opposite side to the fixing rib 213 side with respect to the center of the display panel 204 in top view of the specimen 200. More in detail, the collision position P was set not on the housing frame 209 but on the display panel 204 and in a position 20 mm inside from the end portion of the display panel.

As a result of the collision of the rigidity body model, the specimen was evaluated as “∘” when the cover member was not cracked, and as “x” when the cover member was cracked. Incidentally, in the case of “∘”, it can be evaluated as it shows impact resistance excellent enough not to be cracked even if a head portion or the like of a passenger collides therewith at the time of a collision accident.

### [Impact Resistance Test]

As for the specimens of the pattern I and the pattern II used for the impact resistance test, dimensions of each member and results of the impact resistance test are shown in Table 4. The test was performed fixing the size of the display panel and the size of the cover member while changing the resin width and the size of the glass sheet. The column “size of glass sheet relative to display panel” designates comparison between the size of the main surface of the glass sheet constituting the cover member and the size of the main surface of the display panel. In the column, “large” is entered when the main surface of the display panel was included within the main surface of the glass sheet in top view, and “large” is written when the main surface of the glass sheet was included within the main surface of the display panel in top view. Incidentally, when the main surface of the glass sheet was larger than the main surface of the display panel, the display panel was absent under the end portion of the glass sheet. Therefore, in this case, the thickness t₂ of the display panel (second layer) and the thickness t₃ of the backlight unit (third layer) were both 0 (mm).

TABLE 4

| | | | | size of glass | | cross- |
|---|---|---|---|---|---|---|
| | cover | | | sheet | | sectional |
| | member | display panel | backlight unit | relative to | | secondary |
| | (first layer) | (second layer) | (third layer) | display | impact | moment |
| | thickness t₁ | thickness t₂ | thickness t₃ | panel | resistance | I₁ |
| | mm | mm | mm | — | — | mm⁴ |
| I-1 | 2.0 | 0 | 0 | large | X | 53.3 |
| I-2 | 2.0 | 1.1 | 4.0 | small | ◯ | 1640.4 |
| I-3 | 2.0 | 1.1 | 4.0 | small | ◯ | 1491.3 |
| I-4 | 1.3 | 0 | 0 | large | X | 14.6 |
| I-5 | 1.3 | 1.1 | 4.0 | small | ◯ | 1201.5 |
| I-6 | 1.3 | 1.1 | 4.0 | small | ◯ | 1092.3 |
| I-7 | 1.1 | 0 | 0 | large | X | 8.9 |
| I-8 | 1.1 | 1.1 | 4.0 | small | ◯ | 1092.3 |
| I-9 | 1.1 | 1.1 | 4.0 | small | ◯ | 993.0 |
| I-10 | 0.56 | 0 | 0 | large | X | 1.2 |
| I-11 | 0.56 | 1.1 | 4.0 | small | ◯ | 831.1 |
| I-12 | 0.56 | 1.1 | 4.0 | small | ◯ | 755.5 |
| II-1 | 2.0 | 0 | 0 | large | X | 133.3 |
| II-2 | 2.0 | 1.1 | 4.0 | small | ◯ | 4473.9 |
| II-3 | 2.0 | 1.1 | 4.0 | small | ◯ | 4175.6 |
| II-4 | 1.3 | 0 | 0 | large | X | 36.6 |
| II-5 | 1.3 | 1.1 | 4.0 | small | ◯ | 3276.8 |
| II-6 | 1.3 | 1.1 | 4.0 | small | ◯ | 3058.3 |
| II-7 | 1.1 | 0 | 0 | large | X | 22.2 |
| II-8 | 1.1 | 1.1 | 4.0 | small | ◯ | 2979.1 |
| II-9 | 1.1 | 1.1 | 4.0 | small | ◯ | 2780.5 |
| II-10 | 0.56 | 0 | 0 | large | X | 2.9 |
| II-11 | 0.56 | 1.1 | 4.0 | small | ◯ | 2266.5 |
| II-12 | 0.56 | 1.1 | 4.0 | small | ◯ | 2115.4 |

As is apparent from Table 4, it was proved that impact resistance was not secured when the main surface of the display panel was included within the main surface of the glass sheet in top view as a result of comparison in size between the main surface of the glass sheet constituting the cover member and the main surface of the display panel, while excellent impact resistance was shown when the main surface of the glass sheet was included within the main surface of the display panel in top view.

Here, the cross-sectional secondary moment l₁ was obtained by the above-mentioned Expression (1) using the thicknesses of the members in the first to third layers and the value of the short side a of the glass sheet. The results are shown in Table 4. From the results, it was proved that excellent impact resistance was shown when the cross-sectional secondary moment l₁ at the end portion of the glass sheet was 150 mm⁴ or more. On the other hand, it was proved that when the cross-sectional secondary moment l₁ was less than 150 mm⁴, impact resistance was not shown but the cover member tended to be cracked.

Although the present invention has been described in detail with reference to its specific modes, it is obvious for those skilled in the art that various changes and modifications can be made on the present invention without departing from the spirit and scope of the present invention. The present application is based on a Japanese patent application (Japanese Patent Application No. 2017-82642) filed on Apr. 19, 2017, the contents of which are incorporated herein by reference.

### REFERENCE SIGNS LIST

11: cover member
12: glass sheet
12a: first main surface
12b: second main surface
12c: side surface
14: pressure-sensitive adhesive layer
16: resin-formed article
16a: first resin main surface
16b: second resin main surface
16c: resin inside surface
31: bonding layer
100: display device
102: backlight unit
104: display panel
104a: main surface
104d: corner portion
106: housing
107: housing bottom plate
108: support portion
141: wiring
500: display device
502: backlight unit
504: display panel
504a: main surface
504d: corner portion
506: housing
507: housing bottom plate
512: glass sheet
512a: first main surface
512b: second main surface
512d: position facing corner portion of display panel
514: pressure-sensitive adhesive layer
531: bonding layer
532: shielding portion
541: wiring

1. A cover member to be disposed on a display panel of a display device,
the cover member comprising a glass sheet, and a resin-formed article that is disposed around the glass sheet,
wherein the glass sheet has a main surface smaller than a main surface of the display panel.

2. The cover member according to claim 1, wherein the glass sheet has a side surface that is joined to the resin-formed article, and the glass sheet is supported by the resin-formed article only through the joint between the glass sheet and the resin-formed article.

3. The cover member according to claim 1, wherein the side surface of the glass sheet and the resin-formed article are joined through a bonding layer.

4. The cover member according to claim 1, wherein the glass sheet comprises a first main surface facing the display panel,
the resin-formed article comprises a first resin main surface adjacent to the first main surface of the glass sheet, and
the glass sheet and the resin-formed article are joined to each other, and a height of the first resin main surface based on the first main surface of the glass sheet is within a range of from −50 μm to 50 μm in a region of 2 mm or less from the joint portion between the glass sheet and the resin-formed article.

5. A display device comprising a display panel and a cover member,
wherein the cover member is disposed on the display panel, and comprises a glass sheet and a resin-formed article disposed around the glass sheet, and
the glass sheet has a main surface smaller than a main surface of the display panel.

6. The display device according to claim 5, wherein the glass sheet has a side surface that is joined to the resin-formed article, and the glass sheet is supported by the resin-formed article only through the joint between the glass sheet and the resin-formed article.

7. The display device according to claim 5, comprising a housing storing the display panel,
wherein the glass sheet is not supported by the housing.

8. The display device according to claim 5, wherein the side surface of the glass sheet and the resin-formed article are joined through a bonding layer.

9. The display device according to claim 5, wherein the glass sheet comprises a first main surface facing the display panel,
the resin-formed article comprises a first resin main surface adjacent to the first main surface of the glass sheet, and
the glass sheet and the resin-formed article are joined to each other, and a height of the first resin main surface based on the first main surface of the glass sheet is within a range of from −50 μm to 50 μm in a region of 2 mm or less from the joint portion between the glass sheet and the resin-formed article.

10. The display device according to claim 5, that is a display device of a mobile body.

11. A cover member comprising:
a glass sheet,
a resin-formed article that is disposed around the glass sheet, and
a bonding layer that is disposed between the glass sheet and the resin-formed article so as to join a side surface of the glass sheet with the resin-formed article,
wherein the bonding layer comprises 0.1 mass % or less of an acrylic resin.

12. The cover member according to claim 11, wherein the bonding layer comprises an urethane-based resin component monomer.

13. The cover member according to claim 11, wherein the bonding layer comprises a silane coupling agent.

14. The cover member according to claim 11, wherein the glass sheet comprises a first main surface facing a display panel,
the resin-formed article comprises a first resin main surface adjacent to the first main surface of the glass sheet, and
the glass sheet and the resin-formed article are joined to each other, and a height of the first resin main surface based on the first main surface of the glass sheet is within a range of from −50 μm to 50 μm in a region of 2 mm or less from the joint portion between the glass sheet and the resin-formed article.

15. A display device comprising the cover member according to claim 11, and a display panel.

16. The display device according to claim 15, comprising a housing storing the display panel, wherein the glass sheet is not supported by the housing.
